(19) United States
(12) Patent Application Publication
(10) Pub. No.: US 2002/0139251 A1
(43) Pub. Date: Oct. 3, 2002

(54) Vehicular air cleaner

(76) Inventor: Brenda Joyce Simmons, Canyon Lake, CA (US)

Correspondence Address: Brenda Simmons, 31566 Railroad Canyon Road # 621, Canyon Lake, CA, 92587, US

(21) Appl. No.: 09/823,562

(22) Filed: Mar. 29, 2001

(51) Int. Cl. B01D 53/02

(52) U.S. Cl. 96/134; 96/222; 55/385.3

(57) ABSTRACT

An air filtration system for vehicles, aircraft and spacecraft includes a filter element for filtering air passing through an air vent thereby cleaning the air of toxic substances such as smog, exhaust fumes, noxious gases, diesel fumes, asphalt odors and many other combustion odors., in addition to emitting an aroma scent of fragrance providing a pleasant smell which will not interefere with the cleaning process of the air. The filter having a size and shape such that the filter element fits across the path of the air passing through the air vent and the structure for removably mounting the filter element on the vehicle in the path of air passing through the air vent so that its cleans the air in the enclosed enivronment of the cabin of the vehicles.

### FIELD OF INVENTION

This invention relates to mobile vehicular, aircraft and spacecraft air filtration system, in order to relieve occupants of air pollution.

### BACKGROUND OF THE INVENTION

The present invention relates to air cleaner, and more particularly to air purifier with or without an aroma scent attached to the filter, which is placed onto the air vents in a mobile vehicle, aircraft and spacecraft.

The primary object of the invention is to provide an cleaner air environment to the occupants to eliminate toxic substances in the air of the cabin of the vehicle through the heating system, air conditioning system, recirculation system and fresh air inlets.

As the population increase use of transportation on the highways and in the air, this creates severe air pollution in our society in the 21st century. More pollution is generated, thus causing more illness and shortness of life to the population. The EPA estimates that mobile vehicular ( car, truck, bus, aircraft etc..) sources of air toxics account for as much as half of all cancers attributed to outdoor sources of air toxics. When these toxics enter into an enclosed environment, such as the cabin of a vehicle, aircraft and spacecraft; it can cause signficant damage to one's health.

Various types of filters are known for emitting aromas. Thus, the patent to Dearling, U.S. Pat. No. 3,330,481,, discloses a dispenser for walfing into the atmosphere an insecticide, a pleasant smelling scent or any other aromas,. Similarly, the Sekiguchi et al. U.S. Pat. No. 3,670,133 discloses a perfume dispenser which includes a sponge like head that receives and exudes a charge of perfume. In the spray aerosol can disclosed in the Harrison U.S. Pat. No. 3,972,473, an absorptive rign is impregnated with an air-freshening fragrance and released into the atmosphere. U.S. Pat. Nos. 1,191,821, 3,410,488 and 3,441,353 are along similar lines, for they show wicks and other absorptive materials to accept and emit a perfume or other odoriferous liquid. U.S. Pat. No. 4,523,870 relates to aroma dispensing cartridge and holder assembly attachable to an air vent in the interior of an automobile, to diffuse an aromatic vapor into the forced air stream emitted into the interior.

While the prior art discloses various embodiments of aroma dispensers, none of these devices is particularly adopted for use in an automotive interior that focus on cleaning the air in addition to aroma scent. Hence, those patents tend to mask or supplant these odors by scent instead of cleaning the environment within the vehicle.

A further object of the invention is to provide an air cleaner as described earlier, that will filter out strong toxic pollutants that enters into vehicles interior cabin. For example, within the aircraft, passengers are subjected to airborne bacteria, diesel fuel emmissions and germs that travel throughout. The filter can be placed in front of the air flow system overhead or placed inside the tube that carries the air to the passengers at each individual seating area.

As air pollution increases as mentioned earlier, stop and go rush hour traffic aggravates the problem. The ventilation within these moble vehicles, the vent directs automobile exhaust, asphalt fumes, combustion ordors, fuel gases, industrial fumes, smog and noxious gases directly at the vehicle occupants. Even though the occupant can adjust the air vent flow, recirculate the air, turn on the air conditioning etc.., the toxic substances and fumes still remain in the vehicle.

Devices are known to clean the air, such U.S. Pat. No. 2,881,854, relates to air purifiers for the attachment to the air inlets of internal combustion engine driven vehicles. It primary function is to eliminate odors, dirt, dust and other foreign materials. This patent does not address the heavy toxic substances that are currently in the atmosphere that enters into the vehicle, utilizing only a charcoal filter.

### SUMMARY OF INVENTION

This invention solves the problem outline earlier, by providing an air filtration system that will clean the air and may provide aroma scent combination system that interposes a replaceable filter in the path of air passing through the air vent. The system may include original equipment in newly manufactured vehicles, aircraft and spacecraft or retrofitted components for existing vehicles. In either event, a user can removably mount the filter element on a vehicle across the path of air passing through the air vent where the filter removes strong pollutants and thereby renders the air cleaner.

Generally, a system constructed according to the invention includes a filter element. This filter element can be utilized in front of the air vent where the air can travel through the heating system, air conditioning system, recirculating system, and fresh (not so fresh air, but should be named pollutant air) inlets. The filter size and shape varies with the application of the opening of the air vent, such that it fits across the path of air passing through and its suitable known composition to remove pollutants from air as the air passes through the filter element. For those purposes of an exterior filter, the filter is decorated in various exterior colors and designs to complement the interiors of the vehicles.

The significant advantage of this filter is the embodiment contains a particular new patented aluminosilicrate compound impregnated with potassiam permanganate with an addition of specialized activated carbon. It is designed to oxidize gaseous containinants including hydrogen sulfide, sulfur dioxide, formaldehyde, ethylene, mercaptans, acetaldehyde, diesel particular matter, 1-3 butadiene, benzane, exhaust fumes, dust, dirt and other foreign materials. The majority of these toxic substances are known to probable human carinrogens which causes cancer in human beings.

Also, an object of this invention, a high activity specialty treated activated carbon designed for vapor phase odor control. There is a carbon pad on the exterior of the filter to eliminate various foreign materials that travels through the air.

Another object of the invention, is the location of the filter located in the aircraft for the air quality within the plane as it relates to the comfort of the passengers. The filter is place inside of the overhead cabinet. In some cases, depending on the aircraft, there is a 5.5 inch clearance between the air vent tube and the luggage compartment. The filter is placed inside the air tube which extends through the hole of the cabinet to the passenger overhead air vent. Therefore, the passenger can adjust the air vent as well as the flow for cleaner air ventilation within their seating area. In addition, this filter can be placed on the outside of the air vent. This can be easily installed by the aviation crew in less than 10 minutes to change out old filters for new ones.

Another object of this invention, on the outside frame of the filter, can be covered by a variety of fragrances scented designs but not limited to (oil, powder, dried flowers, leaves and other decorative trimming. This will allow a fragrant scent that will not interfere with the cleaning process of the air emitting through the filter.

Another object of this invention, the outer frame of the filter can be attached to surfaces of the air vents, which is easily installed by Velrco, clips and in some cases screws for means of connections. The user simply uses those components to mount filter on air vent opening within the vehicle. When the used filter element no longer filters and it is filled to capacity, it is removed and a new filter is installed, using the same mounting strips or clips or screws, if desired.

Another object of this invention, of course, other mounting means may be employed within the broader inventive concepts disclosed. Newly manufactured vehicles, for example, include any various known types of mounting techniques to removably mount a replacable filter along the air vent in path of air flowing through the air vent. For that purpose, one vehicle constructed according to the invention includes structure defining two spaced apart channels, one on either of opposites sides of the air vent. The filter element is simply inserted into the channels to mount it in the path of air flowing through the vent and then it is simply slid back out when it it time for replacement. If desired, the mounting means may be configured so that the filter element mounts behind the air vent in a less noticeable position which can be applied to both entities within the scope of this invention.

Another object of this invention, the filter device is easily replacealble, disposable, easy to install and has less restrictive air flow than most standard filters. The shape of the filter can have numerous structural modifications and adaptions may be resorted to without departing from the scope of the appended claims.

### BRIEF DESCRIPTION OF DRAWINGS

FIG. 1a of the drawings is perspective view of an filtration system constructed according to the invention that is installed on air vent opening of the vechicle. FIG. 1b is a diagrammatic representation of the dashboard, the air vent opening through which air passes into the ehicle. FIG. 2 is an enlarged perspective view of the filter element showing the stages of air filtration (24) entry of toxic substances (22) new patented aluminosilctate compound impregnated by potassiam permanganate, and specialty treated activated carbon media (21) frame; metal or plastic (23) frame cover acented by fragrances along the frame which can include decorative designs/in front of filter foam covering for air flow and stability of the enclosed media (25) speciality carbon pad. FIG. 3 is a perspective view of filter apparatus that is particularly well adapted for convenient and advantageous location in vehicles including but not limited to aircraft, spacecraft and ground craft vehicles. FIG. 4 is a view of air tube withing aircraft leading from the main air pack to each passenger overhead air vent.

### DETAILED DESCRIPTION OF THE INVENTION

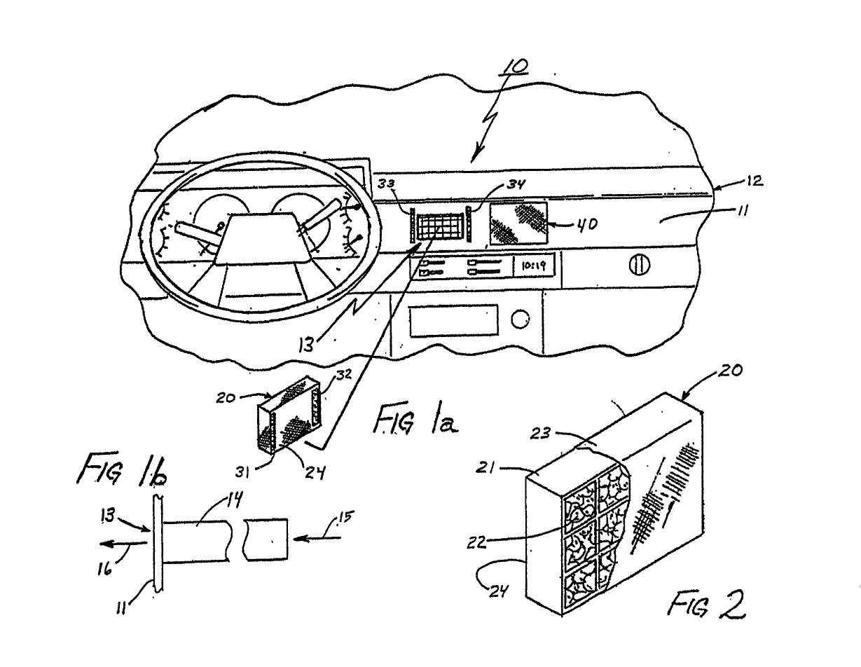

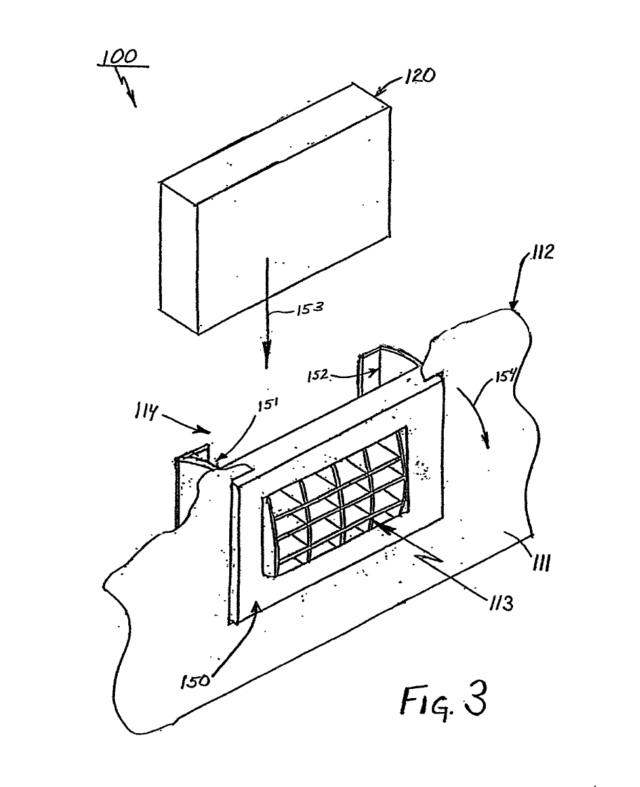

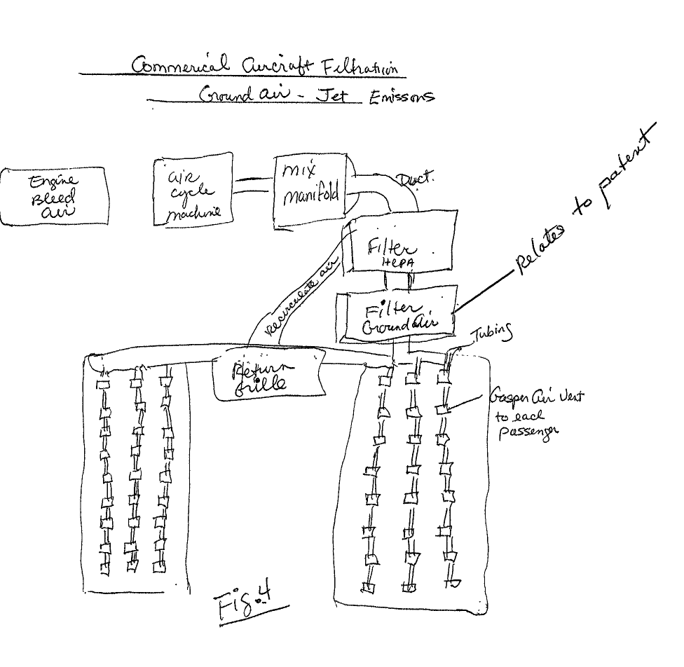

The drawings show air filtration system 10 constructed according to the invention. It is partially installed on a dashboard 11 pf a vehicle 12 over air vent opening 13 (FIG. 1a) in order to filter air passing thru the air vent opering 13. In that regard, the vehicle 12 includes a known type of air vent 14 shown arrow 15 in FIG. 1b. passes in a known manner through the air vent 12 as indicated by an arrow 16. The air filtration system 10 filters the air along the way.

The air filtration system 10 does so after the air passes through the air vent opening 13. However, an air filtration system may be configured according to the invention as subsequently described with reference to FIG. 3 to filter the air before it passes through the air vent oopening 13. That can result in a more aesthetically pleasing installation.

Generally, an air filtration system constructed according to the invention (e.g. the system 10)includes filter element for filtering air passing through an air vent in a vechicle (such as a filter element 20 in FIGS. 1a. and 2) and means for removably mounting the filter element on the vehicle in the path of air passing through the air vent so that a substantial amount of the air passes through the filter element. The filter element has a size and shape such that the filter element fits across the path of air passing through the air vent and the user simply mounts in the path of the air and replaces it with an unused filter element as needed.

With regard to the system 10, the filter element 20 takes the form of an assembly measuring about three inches wide, four and one half inches long and one inch thick. It includes a metal and/or plastic framework 21 within that divides the interior into embedded cell chambers in V shaped forms/and or squares (FIG. 2) each compantment containing a patented type of filter material as describe earlier in summary of invention, such as material 22 in FIG. 2 A conforming cover 23 of porous and foam material, such as a canvas as well as a carbon pad in rear to collect and filter foreign materials and other air-breathable fabric material covers the framework to retain the filter material in place and outside such a scented materials for the aroma scent which will provide an attractive exterior along with various desgns techiques to comment the interior of the vehicle.

In the system 10, the means for removably mounting the filter element 20 on the vehicle 12 includes four mounting strips (two shown) 31 and 32 of hook and loop fastener material attached to the reaward side 24 of the filter element 20 as shown in FIG. 1a. which can be applied horizonal or vertical, depending upon the shape of the interior or exterior air vent. (such as that sold under the tradename VELCRO) and four mounting strips 33 and 34 of hook and loop fasterner material (two shown)that can be attached to the dashboard 11/and or air vent opening. The mounting strips 33 and 34 may have a known type of self-adhesive backing. To install the filter element 20, the user attaches the mating strips 33 and 34 to the mounting strips 31 and 32 on thre rearward side 24 of the filter element 20. Of course, they may already attached at purchase. Next, the user removes a protective strip covering the self-adhesive backing on each of the mating mounting strips 33 and 34. Then, the user positions the filter element 20 over the air vent opening 13 and presses it toward the dashboard 11 so that the self-adhesive backing attaches the mating mounting strips 33 and 34 to the dashboard 11 on opposite sides of the air vent opening 13. That results in an installation such as that depicted by a second filter element 40 in FIG. 1a that is mounted on the dashboard 11 over a different air vent opening in the vehicle 12.

From the foregoing and subsequent descriptions, it becomes apparent that any of various types of filter elements and mounting techniques may be employed within the broader inventive concepts disclosed, and any such variations are intended to fall within the scope of the claims. The filter element 20 may have a different size and shape, for example, although the illustrated size and shape fits over the air vent openings in many existing vehicles. In that regard, the filter element has been described as having a size and shape such that the filter element fits across the path of air passing through the air vent. Thus, the size and shape is only restricted by the particular installation contemplated.

One variation is illustrated in FIG. 3 by an air filtration system 100. Broadly speaking, it is similar in many respects to the air filtration system 10 so that only differences will be discussed in further detail. For convenience, numerals designating parts of the system 100 are increased by one hundred over numerals designating similar parts of the system 10.

Like the system 10, the system 100 includes a filter element 120 that has a size and shape such that the filter element 120 fits across the path of air passing through the air vent 11. But unlike the system 10, the system 100 is configured with mean for removably mounts the filter element 20 on the vehicle 112 so that opening 113 (i.e., on a side of the dashboard 111 opposite occupants of the vehicle 112). That is accomplished in the illustrated system 100 by fabricating the vehicle 112 with a special fixture 150 over the air vent opening 113.

The fixture 150 defines two opposing channels 151 and 152 into which the user inserts the filter element 120 by moving it in the direction of an arrow 153 in FIG. 3. When inserted into the channels 151 nad 152, the filter element 120 is positioned across the pathe of air passing through the air vent 114 and out the air vent opening 113. The fixture may be movably mountted on the vehicle 112 by suitable known means so that it can be manually pivoted in the direction of an arrow 154 in order to expose the channels 151 and 152 (i.e. move them to an accessible position ahead of the dashboard 111). Then the filter element 120 is inserted and the fixture 150 pivoted back to the closed position illustrated for use. When the filter element 120 needs to be replaced, the user pivots the fixture back to the closed position.

Thus, the invention provide an air filtration system that interposes a replaceable filter element in the path of air passing through the air vent that cleans the air of toxic substances as well as promote an scent of pleasant (scented) smell within the interior cabin of a vehicle including but not limited to ground craft aircraft, spacecraft and marine craft and the like. The system may be configured as original equipment or retrofitted components. It removes pollutants from the air and releases a pleasant smell thereby renders the air cleaner and far less objectionable.

Although an exemplary embodiment has been shown and described, many changes, modifications, and substitutions may be made by one having ordinary skill in the art withour necessarily departing from the spirit and scope of the invention.

What is claimed is:

1. What I claim my invention is a air filtration system that allows the occupants within a vehicle, aircraft, spacecraft and ground craft to receive an cleaner air environment within an enclosed cabin of the vehicle, which filter out toxic substances that enters in the air vents throughout the cabin, by placing a filter in front of the air passing through the vent(s) with a filter comprising of a particular patented aluminosilicrate compound impregnated with postassium permanganate with an addition of specialized activated carbon embedded inside the filter with a cell encasement, and a rear activated carbon pad to remove various harmful and toxic odors, in addition to scented fragrant materials on the exterior of the filter to emit pleasant smells which do not interfere with the cleaning process of the said filter, the structure of the filter can be in numerous sizes and shapes that will accomodate the covering of the air vent to filter the air effectively, which can be placed on the exterior or interior of the air vent with the air passing through it, in addition, the filter can be housed inside of a tubular container within certain vehicles (aircraft and spacecraft) to pass thru the filter in order to reach the air vent inside the cabin of the vehicle to reach each individual passenger in its overhead compartments and the filter can be attached easy by tradename velcro, clips and or screws, which can be installed by the occupant/passenger in a fast and easy matter, which the filter element can be square, rectangle, circular, sysmetical, cylinder and within the dimensions of the said air vent in which the filter is to be applied or attached to said housing of the air vent.
